(19) United States
(12) Patent Application Publication
(10) Pub. No.: US 2016/0253701 A1
(43) Pub. Date: Sep. 1, 2016

(54) METHODS AND SYSTEMS FOR MONETIZING EDITORIAL USER-GENERATED CONTENT VIA CONVERSION INTO AFFILIATE MARKETING LINKS

(71) Applicant: Skimbit Ltd., London (GB)

(72) Inventors: Alicia Navarro, London (GB); Joe Stepniewski, London (GB); Matthieu Pivard, London (GB); Ciaran Rooney, London (GB)

(21) Appl. No.: 14/509,374

(22) Filed: Oct. 8, 2014

Related U.S. Application Data
(63) Continuation of application No. 12/554,816, filed on Sep. 4, 2009, now abandoned.
(60) Provisional application No. 61/094,368, filed on Sep. 4, 2008.

(51) Int. Cl. G06Q 30/02; H04L 29/12; H04L 29/08

(52) U.S. Cl. CPC G06Q 30/0247; H04L 67/02; H04L 61/6095

(57) ABSTRACT

Methods and systems for monetizing editorial and user-generated content via conversion into affiliate marketing links. Aspects of the disclosure, for example, are directed to methods and systems configured to enable rewriting of URLs based on a synchronized database of merchants collected from a breadth of affiliate networks. In several embodiments, for example, upon posting of a URL to a user-generated website or on clicking of a URL on such a site by a user, the server system compares the domain name of the URL against a database of merchants synchronized across multiple affiliate networks. When a merchant's domain name is found, the server system may convert the URL using a deep linking syntax outlined in the merchant database so that the URL becomes an affiliate link that leads to the original URL via the corresponding affiliate network. User clicks on this converted URL may generate affiliate commissions.

### CROSS-REFERENCE TO RELATED APPLICATION

This application claims the benefit of U.S. Provisional Patent Application No. 61/094,368, filed Sep. 4, 2008, which is incorporated herein by reference in its entirety.

### TECHNICAL FIELD

The following disclosure relates generally to methods and systems for monetizing editorial and user-generated content.

### BACKGROUND

Website publishers have a need to monetize their website content. Some achieve this by using e-commerce to sell products or services via their website, and earn a margin on the goods they sell online. Another common form of website monetization is display advertising in which some of the site's real estate is used to display banner or text advertisements. Each time a website page is loaded (called a “page impression” or “page view”), the advertisement is shown again. The revenue generated from displaying these advertisements is based on a number of different models. Many banner advertisements are charged a cost per thousand basis, commonly referred to as CPM. This means an advertiser pays based on the number of times the ad is viewed on a page impression. For example, if user traffic to a site resulted in 2000 page impressions and the advertiser was willing to pay $10 CPM, the website publisher would earn $20 for showing that ad on their site.

Another model used to charge display advertising is “cost per click,” commonly referred to as CPC. This method has been popularized by Google AdSense and other advertising networks offering text based advertisements. In this model, the advertiser sets how much they are willing to pay for each click on their ad, regardless of how often it is displayed. For example, if an advertiser set a CPC for their ad of $0.20 and this text ad was shown 1000 times on a website, but was only clicked on 5 times by users to this website, the website publisher earns $1.00 in revenue. Although there are other models for charging advertisers, CPM and CPC are the most common.

Finally, more recently, another way to monetize sites has evolved. This is called “online lead generation” or “affiliate marketing.” This method involves advertisers paying website publishers for successful leads, acquisitions, or completions of certain defined activities on their site. The publisher then earns either a commission on the value of the sale or a fixed cost per acquisition (referred to as CPA). The advertisement can take the form of a traditional banner or text ad, or it can take the form of published editorial content created by the website publisher. For example, an advertiser may elect to pay a CPA of 5% of the value of the sale, and a website publisher creates editorial content about a product valued at $100 on the advertiser's site and provides a link to the advertiser's site. Regardless of how many times the publisher's website page is shown or how many times users click through from the publisher's website to the advertiser's website, the publisher only earns its $5 affiliate commission revenue when a user clicks on this link and completes a sale on the advertiser's site.

To track these click-throughs to advertiser sites and to enable payment of commissions to publishers, special affiliate links have to be used instead of normal links to publisher sites. These affiliate links carry information with them that identifies the source of the click-through so commissions can be accurately payable. To facilitate this process, organizations called “affiliate networks” have arisen. Affiliate networks act as a middle-man between advertisers (commonly called “merchants”) and publisher sites (commonly called “affiliates”). Affiliate networks recruit merchants and affiliates, and provide the infrastructure for affiliate marketing to work and be accurately traceable. The mechanism used by most affiliate networks is to create a special syntax for affiliate links that, when clicked, force a redirect to the affiliate network's site, and deposit a cookie on the user's computer. When a user is completing a sale on the merchant's site, the merchant checks to see whether their cookie is present on the user's machine. If it is, they can access information from the cookie about the affiliate that generated the sale lead, and can then attribute the sales commission to that affiliate. Merchants can set the commission structure and cookie lifetime via the affiliate network. For instance, a merchant may decide to assign a cookie lifetime of 60 days, which means any sale made on the merchant's site by a user within 60 days of them first visiting the merchant's site via the affiliate site, is commission-generating for the affiliate.

There are now scores of affiliate networks offering programs for thousands of online merchants. Affiliate marketing is now a booming method for website monetization, growing 71% in the United States between 2005 and 2006 and representing 7.5% of total Internet ad spend in 2006. Each of these affiliate networks has a different syntax for creating affiliate links. Some affiliate networks simply append an affiliate ID into the original URL. Others require a redirect via the affiliate network in order to download the cookie to the user's machine. The syntax used to create this redirecting URL varies, with many supporting “deep linking.” Deep-linking is the ability to create an affiliate link dynamically that takes the user directly to a particular page on the merchant's site. The opposite of deep linking is where the merchant only supports the creation of affiliate links to pre-defined sub-set of URLs within their site. Deep linking is especially useful if an affiliate creates editorial content about a specific product and wants to link to its specific page on the merchant's site, and earn commission on its sale, even if it isn't in the pre-defined sub-set of URLs offered by the merchant.

Some affiliate networks offer an Application Programming Interface (API) that allows affiliates to easily pull information about their merchants' affiliate programs and deep linking syntax on demand. Other networks do not provide an API, but permit affiliates to extract merchant information and deep linking syntax from their systems using automated data extraction scripts created by affiliates. A common way affiliates use affiliate links on their site is to pull merchant and product information from affiliate networks, and display it on their sites in a price-comparison way. Popular examples of affiliate sites are travelsupermarket.com, moneysupermarket.com, confused.com. These involve affiliates publishing content about merchant's products as pulled from affiliate network's systems. They earn their revenues by attracting users to their site, and pushing them to click through on their published content so they complete a sale on the merchant's site.

### BRIEF DESCRIPTION OF THE DRAWINGS

FIG. 1 is a block diagram of a basic and suitable computer that may employ aspects of the disclosure.

FIG. 2 is a block diagram illustrating a simple, yet suitable system in which aspects of the disclosure may operate in a networked computer environment.

FIG. 3A is a block diagram illustrating the interaction and data flow between various components of a system for monetizing editorial and user-generated content via conversion into affiliate marketing links in accordance with several embodiments of the disclosure.

FIG. 3B is a block diagram illustrating various components of a system for monetizing editorial and user-generated content via conversion into affiliate marketing links configured in accordance with several embodiments of the disclosure.

FIGS. 4-8 are flow diagrams illustrating various aspects of methods or routines for monetizing editorial and user-generated content via conversion into affiliate marketing links in accordance with several embodiments of the disclosure.

### DETAILED DESCRIPTION

### A. Overview

The following disclosure is directed generally to methods and systems for monetizing editorial and user-generated content by conversion and auto-validation of affiliate links. Aspects of the disclosure, for example, are directed to methods and systems configured to enable seamless and transparent rewriting of URLs based on a synchronized database of merchants collected from a breadth of affiliate networks. In several embodiments, for example, upon posting of a URL to an editorial or user-generated website or on clicking of a URL on such a site by a user, the server system compares the domain name of the URL against a database of merchants compiled by synchronizing across multiple affiliate networks. When a merchant's domain name is found in the database, the server system may convert the URL using a deep linking syntax outlined in the merchant database so that the URL becomes an affiliate link that leads to the original URL via the corresponding affiliate network. Any user-clicks on this converted URL that lead to a sale on the merchant's site will earn affiliate commissions.

The server system can also regularly and automatically validate the accuracy of the converted URLs to ensure they are not outdated, no longer available, or unreachable. To deduce this, the server system can compare the browser title tag of both the converted URL and the original URL on a regular basis, and flag any URL where they do not match. In several embodiments, a manual review may be conducted for all exceptions raised, thus resulting in a manual rewrite of the broken URL or the restoration of the original URL with a flag signifying future conversions should be bypassed.

As described in greater detail below, one feature of various embodiments of the system described herein is that the system can monetize editorial and user-generated content via conversion of affiliate links across multiple affiliate networks, some of which do not support deep linking. For example, dynamic and unknown URLs published by a site's editors or users (e.g., as part of a blog, online magazine, forum or social bookmarking site) can be converted into monetizable affiliate links across any number of affiliate networks, irrespective of their deep linking capabilities. Moreover, the system is largely self-automated and self-validating. Various embodiments of the systems and associated methods in this disclosure are accordingly expected to allow website publishers to monetize their editorial and user-generated content in a seamless, automated, and unobtrusive way, without compromising on the integrity of the user experience.

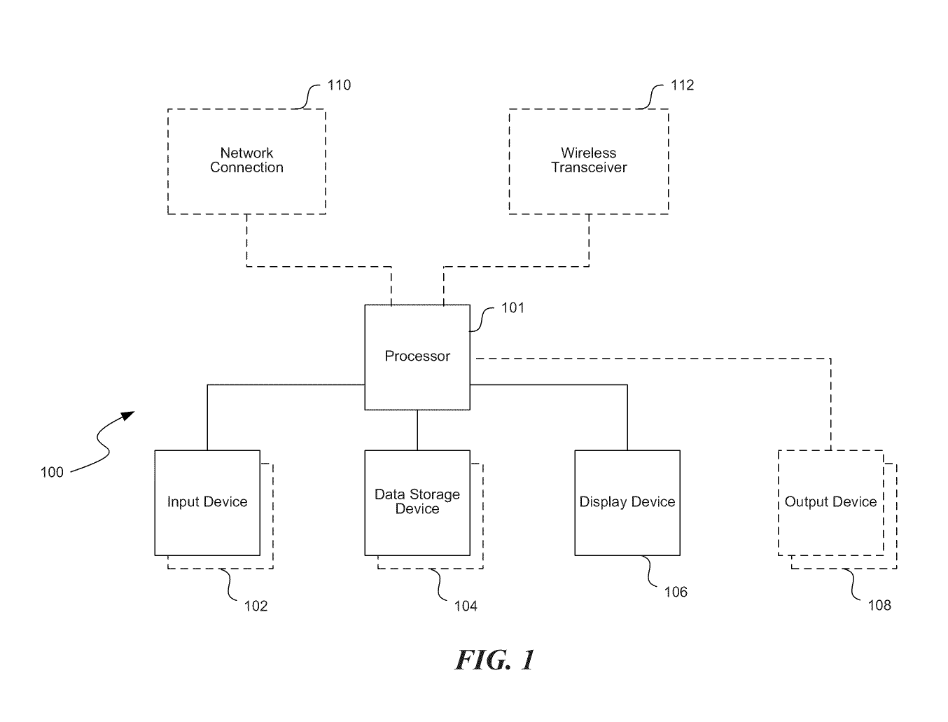

Certain specific details are set forth in the following description and FIGS. 1-8 to provide a thorough understanding of various embodiments of the disclosure. Well-known structures, systems, and methods associated with such systems have not been shown or described in detail to avoid unnecessarily obscuring the description of the various embodiments of the disclosure. In addition, those of ordinary skill in the art will understand that various embodiments of the disclosure may be practiced without several of the details described below.

The terminology used in the description presented below is intended to be interpreted in its broadest reasonable manner, even though it is being used in conjunction with a detailed description of certain specific embodiments of the disclosure. Certain terms may even be emphasized below; however, any terminology intended to be interpreted in any restricted manner will be overtly and specifically defined as such in this Detailed Description section.

A. Suitable Computing Environments in which Aspects of the Disclosure can be Implemented

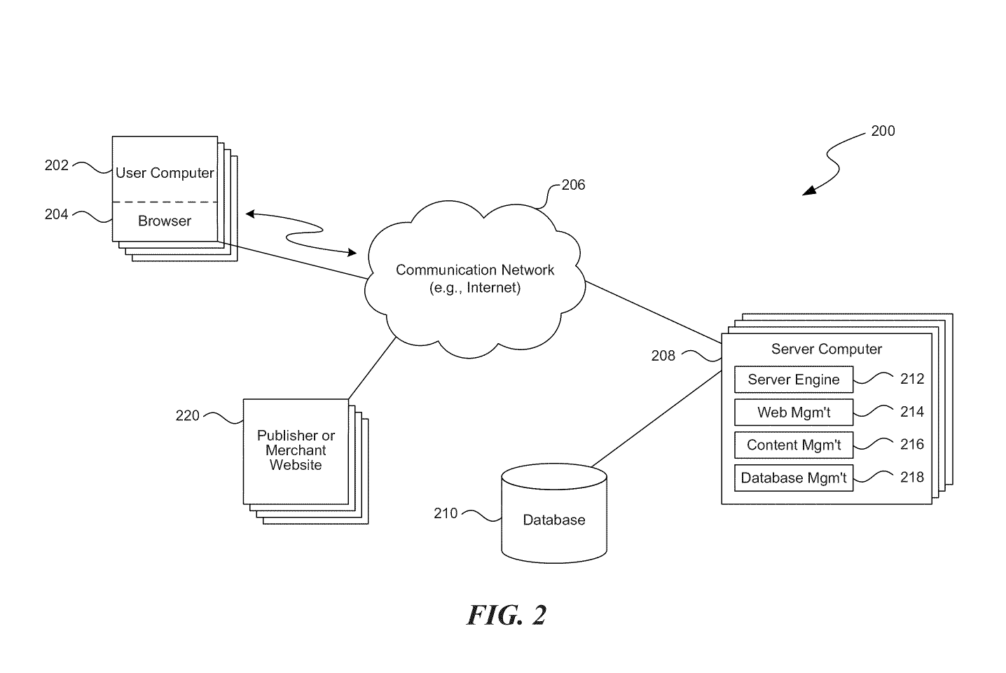

FIGS. 1 and 2 and the following discussion provide a brief, general description of a suitable computing environment in which aspects of the disclosure can be implemented. Although not required, aspects and embodiments of the disclosure will be described in the general context of computer-executable instructions, such as routines executed by a general-purpose computer (e.g., a server or personal computer). Those skilled in the relevant art will appreciate that the disclosure can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. Several embodiments of the disclosure can be embodied in a special purpose computer or data processor that is specifically programmed, configured, or constructed to perform one or more of the computer-executable instructions explained in detail below. Indeed, the term “computer” as used generally herein refers to any of the above devices, as well as any data processor or any device capable of communicating with a network, including consumer electronic goods such as game devices, cameras, or other electronic devices having a processor and other components (e.g., network communication circuitry).

Several embodiments of the disclosure can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or sub-routines may be located in both local and remote memory storage devices. Aspects of the invention described below may be stored or distributed on tangible computer-readable media, including magnetic and optically readable and removable computer discs, stored as firmware in chips (e.g., EEPROM chips), or alternatively distributed electronically over the Internet or over other networks (including wireless networks). Those skilled in the relevant art will recognize that aspects of the disclosure may reside on a server computer, while corresponding portions reside on a client computer. Data structures are also encompassed within the scope of the disclosure.

Referring to FIG. 1, one embodiment of the disclosure employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a LAN, WAN, or the Internet (not shown in FIG. 1).

As mentioned above, aspects of the disclosure may be practiced in a variety of other computing environments. Referring to FIG. 2, for example, a distributed computing environment includes a system 200 having one or more user computers 202, one or more publisher or merchant websites 220, and at least one server computer 208 interconnected via a communication network 206 (e.g., the Internet). The individual user computers 202 can each include a client application, such as a browser program module 204 that permits the computer to access and exchange data with a communication network 206 (e.g., the Internet), including Web sites within the World Wide Web portion of the Internet (although other networks and network access applications may of course be employed). The user computers 202 may be substantially similar to the computer 100 described above with respect to FIG. 1. User computers 202 may include other program modules such as an operating system, one or more application programs (e.g., word processing or spreadsheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below. The use of a web browser and web interface are used as a familiar example here.

The server computer(s) 208 coupled to the network 206 performs much or all of the functions for receiving, routing and storing of electronic messages, which may at times include web pages, audio signals, and electronic images. While the Internet is shown in the illustrated embodiment, a variety of different types of networks, such as an intranet, an extranet, virtual private network (VPN), a non-TCP/IP based network, or the like, may be preferred in some applications. The network 206 may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers 202. The server computer(s) 208, including the database(s) 210, may employ security measures to inhibit malicious attacks on the system 200, and to preserve integrity of the messages and data stored therein (e.g., firewall systems, secure socket layers (SSL), password protection schemes, encryption, and the like).

The server computer 208 may include a server engine 212, a web page management component 214, a content management component 216, and a database management component 218. The server engine 212 performs basic processing and operating system level tasks. The web page management component 214 handles creation and display or routing of web pages. Users may access the server computer 208 by means of a URL associated therewith. The content management component 216 handles most of the functions in the embodiments described herein. The database management component 218 includes storage and retrieval tasks with respect to the database 210, queries to the database 210, and storage of data such as video, graphics, and audio signals. The server computer 208 may obtain data from other computers (and their associated databases), including other server computers (not shown).

In embodiments including multiple servers 208, a load balancing system (not shown) may be employed to balance load(s) on the server computers. Load balancing is a technique well-known in the art for distributing the processing load between two or more computers, to thereby more efficiently process instructions and route data. Such a load balancer can distribute message traffic, particularly during peak traffic times. A distributed file system may also be used in such embodiments to couple the servers to multiple databases. A distributed file system is a type of file system in which the file system itself manages and transparently locates pieces of information (e.g., content pages) from remote files or databases and distributed files across the network, such as a LAN. The distributed file system also manages read and write functions to the databases. In other embodiments, the computing environments described above can have other arrangements, including more, fewer, and/or different components.

C. Embodiments of Methods and Systems for Monetizing Editorial & User-Generated Content Via Conversion into Affiliate Marketing Links

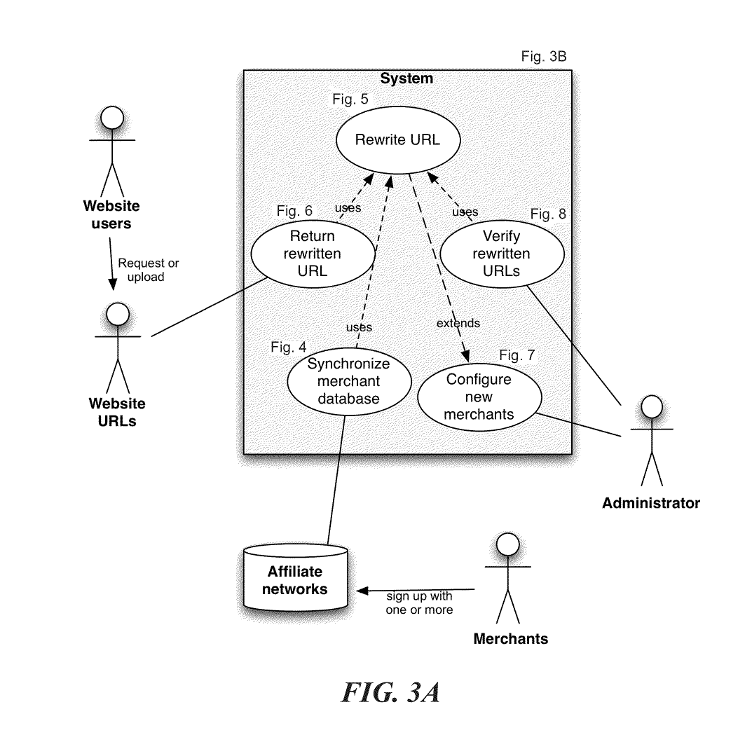

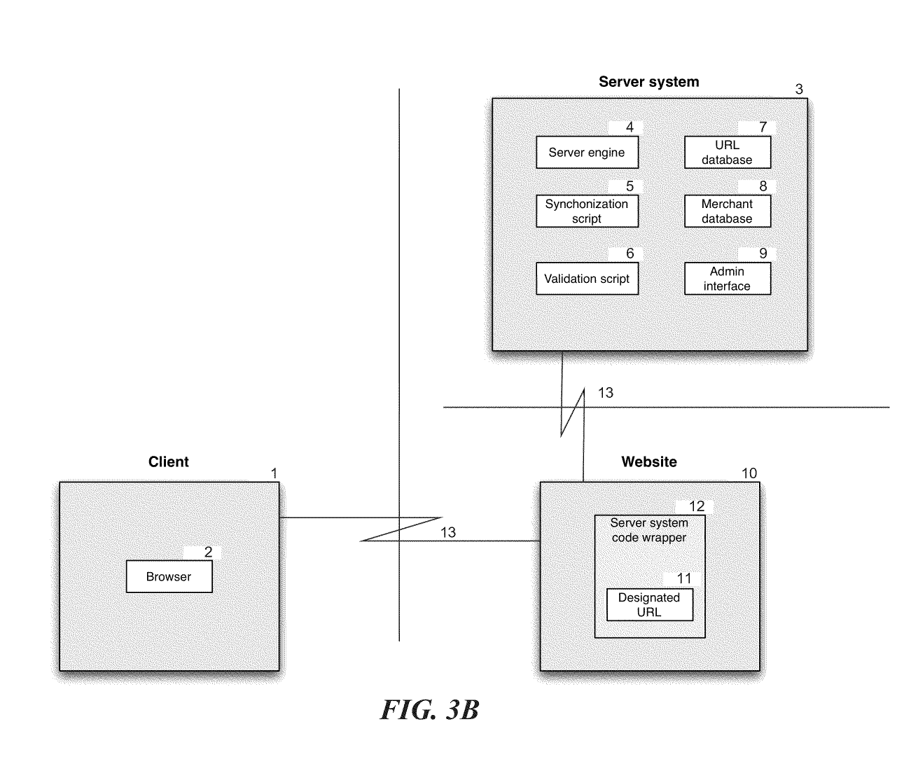

FIGS. 3A-8 illustrate various aspects of systems and methods for monetizing editorial and user-generated content via conversion and auto-validation of affiliate links in accordance with several embodiments of the disclosure. As described in greater detail below, for example, in one embodiment the system can be initiated when a designated external URL is posted to a website by a user. The website then uses the server system's code wrapper to send a request to the server system for the URL to be rewritten, and the returned rewritten URL is displayed on the website. In another embodiment, however, the system can be initiated when a user clicks on a designated external URL on a website. The website then uses the server system's code wrapper to initiate a request to the server system for the URL to be rewritten and validated on the fly, and have the user be redirected automatically to the rewritten URL. In still other embodiments, a variable may be sent to the server system and a corresponding rewritten URL can be returned. The appropriate embodiment can be selected based on the requirements of the website publisher.

Embodiments of the system and associated method can include (a) synchronization of a merchant database, (b) URL rewriting, (c) a component for returning/redirecting to rewritten URL, (d) new merchant configuration, and (e) automated URL verification. The creation and regular synchronization of the merchant database is typically an initial process. The merchant database generally contains data related to the merchant, its affiliate network/s, and their affiliate program with this network. The merchant data can also include manually updated information, such as deep linking details, their status within the merchant database, and any overrides including status and deep linking syntax. Some affiliate networks may include APIs that enable this synchronization, while other networks may require special custom integration using automated data extraction techniques. In one embodiment, for example, this synchronization occurs nightly during a low usage period of time. The server system connects to each of the affiliate networks in sequence, compares the merchant database with the affiliate networks' data, and updates any changes to the merchant's data in the merchant database. In one embodiment, an administrative interface may be created that allows administrator(s) of the system to monitor the status of each of the merchants, and enter any overrides to the status or deep linking status.

The URL rewriting process can be initiated either when a user clicks a designated URL or a designated URL is added to a site by a user. The system is configured to support either situation, and sites can choose which process best suits their particular business needs. Link rewriting is the process of converting a regular URL that links to some website to an affiliate link if the domain name of the link matches a domain name in the merchant database—and therefore able to earn commissions via the affiliate network instead of just linking to the website directly.

In one embodiment, for example, the system compares the domains of URLs of designated URLs with domains in the merchant database. If a match is found, the URL is rewritten based on either the standard syntax specified by the affiliate network, or if the deep link override flag is set in the merchant database, the manually updated deep link syntax in the merchant database. In one embodiment, this new value can be stored in a URL database, and the process can continue for each designated URL. These rewritten URLs may be used when a user either adds or clicks on a designated URL on a site. The system can use the rewritten URL stored in the database instead of the original URL. In situations in which the merchant does not support deep linking, an alternate deep linking method can be used. In some embodiments, the alternate deep linking method includes opening two browser windows, one with an affiliate link and the second with the user's requested original URL. In some embodiments, the alternate deep linking method uses an inline frame, or iframe, to load an affiliate link for the merchant for a short amount of time, before redirecting to the user's requested original URL.

The system is generally self-automated and self-validating. In several embodiments, however, the system may include one or more manual tasks to be performed by a system administrator (e.g., configure new merchants, validate broken affiliate links highlighted by the system, etc.) By way of example, although the synchronization, rewriting, and displaying of affiliate links are generally done automatically by the system, in some instances there may be a degree of manual intervention required to configure new merchants in the system. For example, the system can alert an administrator when a designated URL is being considered for rewriting, and finds a match in the Merchant Database, but without a status of “Joined.” The administrator subsequently joins the merchants affiliate program through the appropriate affiliate network, and then tests the deep link rewriting process to ascertain if the merchant supports deep linking or if it needs to be overridden with a manual deep linking syntax. Once these settings have been correctly configured in the merchant database, the merchant's URLs added to a site can be correctly rewritten to be affiliate links.

Still another aspect of the system is an automated component for verifying the integrity of rewritten links. Because rewritten links can expire or become unavailable (e.g., a HTTP 404 Page Not Found error) over time, automated testing of links can be done to ensure that a user clicking on a designated URL is taken to the page they expect to be taken to. In several embodiments, this process can be done automatically by running a server script regularly that loads both the original un-rewritten URL and the rewritten URL and compares their browser title tag. If they are the same, it is assumed the rewritten URL is still valid. If the tags are different, the URL can be flagged for manual inspection by a system administrator. During the manual review, the administrator can test each flagged rewritten URL and if the destination is now outdated, no longer available, or unreachable, either the rewritten URL is updated so it does return the correct page for the user, or the URL is flagged as un-rewriteable and is returned to its original state. One feature of the link testing process described above is that it utilizes an automated approach to efficiently and accurately test two site's similarities.

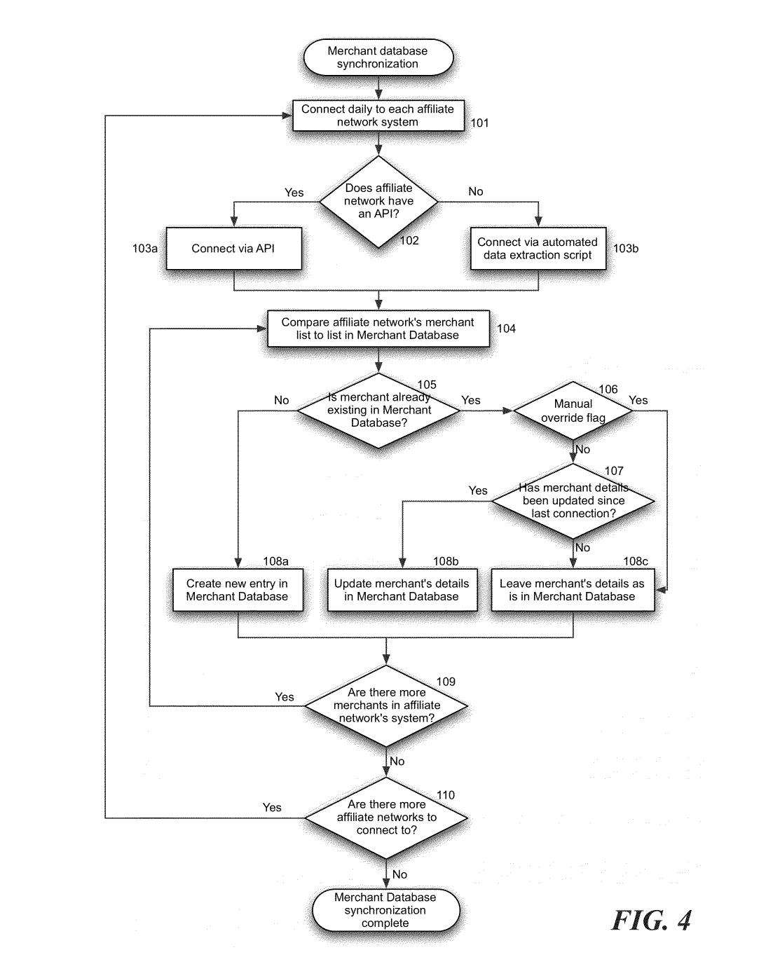

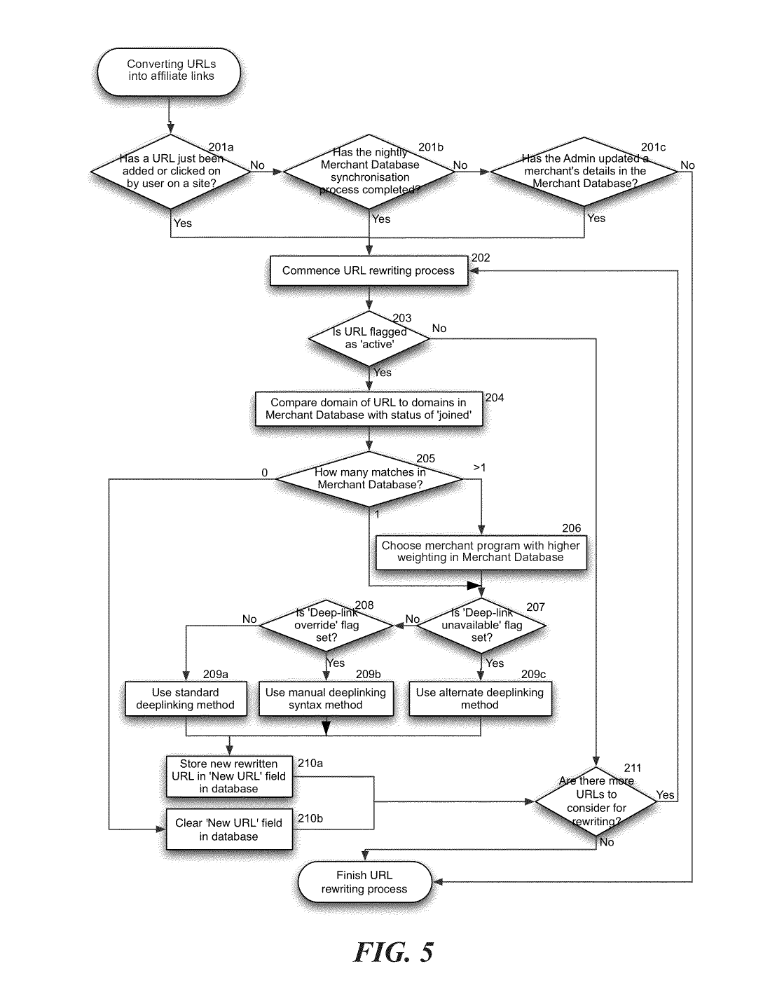

FIG. 3A is a block diagram illustrating the interaction and data flow between various components of a system for monetizing editorial and user-generated content via conversion into affiliate marketing links in accordance with several embodiments of the disclosure. In one embodiment, for example, merchants can sign-up with one or more affiliate networks, and a server system initiates the synchronization of one or more merchant databases (described in greater detail below with reference to FIG. 4). This process triggers the URL rewriting process to rewrite the URLs relating to newly joined merchants. The URL rewriting process (described in greater detail below with reference to FIG. 5) can also be triggered by other processes in the system.

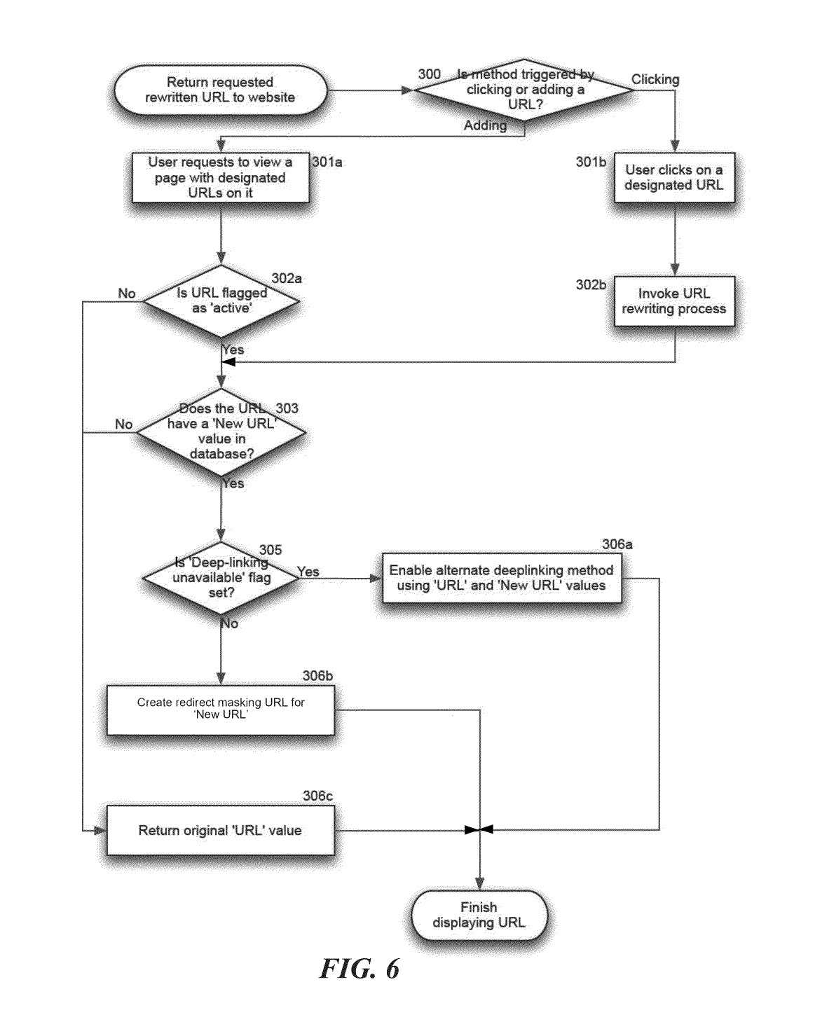

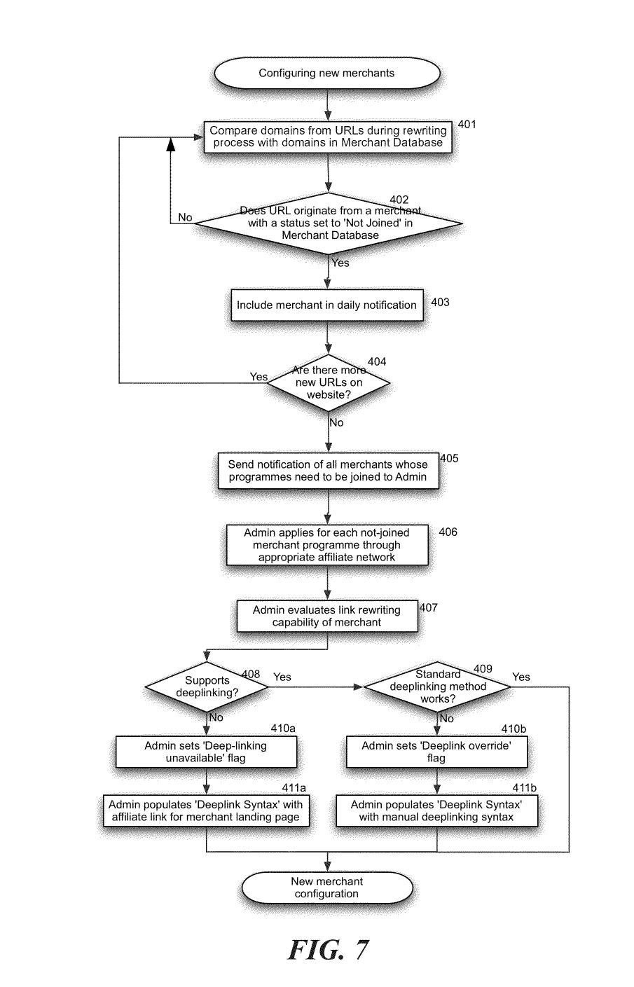

In another aspect of the system, website users can request or upload a URL to a website owned by a third-party publisher. This publisher can use the server system's code wrapper to send a designated URL and request a rewritten URL back. For the server system to return the rewritten URL (described in greater detail below with reference to FIG. 6), it triggers the URL rewriting process and returns the response to the website. During the process of rewriting URLs, if the server system encounters a merchant's affiliate program that is unjoined, the server system can initiate a configure new merchants process (described in greater detail below with reference to FIG. 7), which can be partly driven by the system administrator.

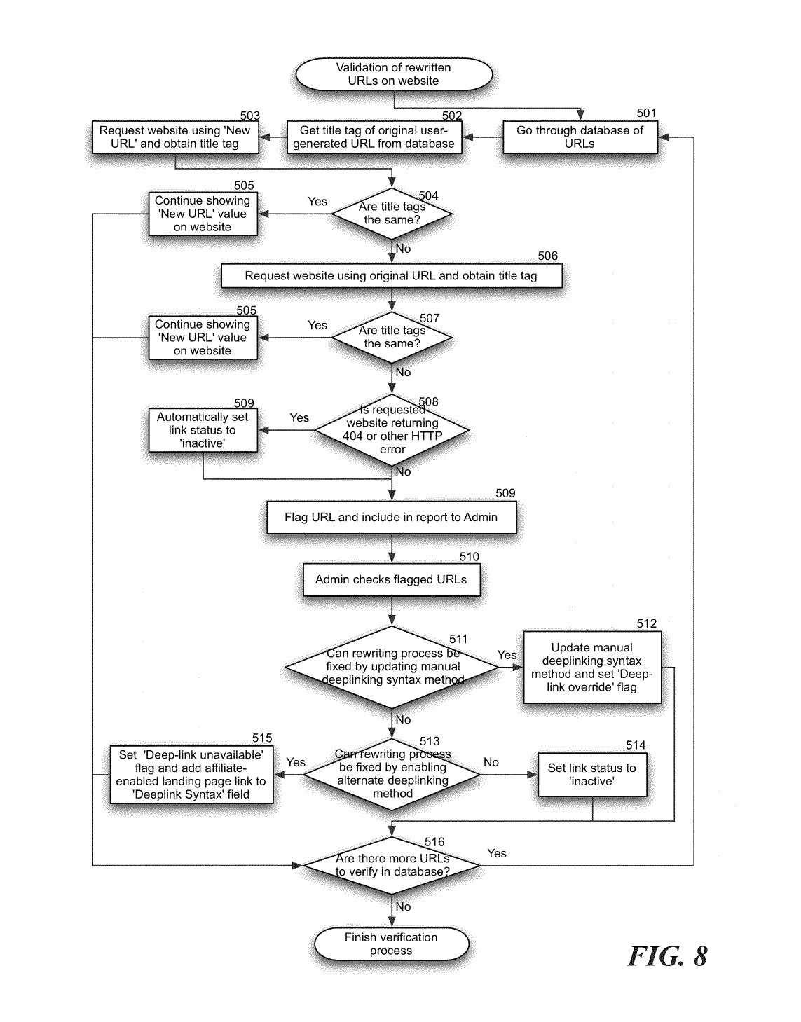

The server system can also be configured to regularly initiate a process of verifying rewritten URLs (described in greater detail below with reference to FIG. 8). In some embodiments, this process may include some manual involvement by the system administrator. This process may also trigger the URL rewriting process for URLs that have become invalid in their current state.

FIG. 3B is a block diagram illustrating various components of a system for monetizing editorial and user-generated content via conversion into affiliate marketing links configured in accordance with several embodiments of the disclosure. The system can include a number of computer components having features generally similar to the computer and network components described above with reference to FIGS. 1 and 2.

The system can include, for example, a client system 1 including a web browser 2 to access a website 10 via a communication network 13 (e.g., the Internet). The website 10, which may be owned by a third-party publisher, uses a server system's code wrapper 12 around a designated URL 11. This may be a user-generated external URL or a publisher added external URL. Moreover, other embodiments are possible in which a keyword or keywords are sent and the server system maps this keyword to a URL or merchant name and returns an appropriate rewritten URL for display on the website 10.

The website 10 can then pass this designated URL over the network 13 to a server system 3. The server system 3 can include a number of components. For example, the server system 3 can include a server engine 4 configured to control operation of the various components of the server system 3. The server system 3 can also include a synchronization script 5 configured to synchronize the merchant database (described in greater detail below with reference to FIG. 4). The server system 3 can further include a validation script 6 configured to verify rewritten URLs (described in greater detail below with reference to FIG. 5), a URL database 7 configured to store details of all requested and rewritten URLs, and a merchant database 8 configured to store details of all merchants and their affiliate programs, synchronized with all partner affiliate networks. The server system can also include an administrator interface 9 configured for use by the system's administrator to manually override and verify rewritten URLs, edit merchant settings, add weightings to different affiliate programs, etc.

For purposes of brevity and clarity, the block diagram of FIG. 3B is referred to in its entirety as illustrating a system for monetizing editorial and user-generated content via conversion into affiliate marketing links. It will be appreciated, however, that this description may also be applied to various individual components or subsets of components of the block diagram of FIG. 3B. Furthermore, the arrangement of the various components in the system is merely intended to demonstrate one possible architecture of a system configured in accordance with aspects of the disclosure. In several embodiments, for example, the system may be a subcomponent of, linked with, or otherwise associated with a larger electronic commerce system. In still other embodiments, the system can have a variety of other arrangements and/or features.

FIGS. 4-8 are flow diagrams illustrating various aspects of methods or routines for monetizing editorial and user-generated content via conversion into affiliate marketing links in accordance with several embodiments of the disclosure. In one aspect of this disclosure, some or all portions of the methods described herein may be performed automatically by the system. In other embodiments, however, various portions of the methods may be performed manually by a system administrator of by other entities.

FIG. 4, for example, is a flow diagram illustrating a method or routine for synchronizing the merchant database on a regular basis. The process can be scheduled to run automatically on a regular basis. In one embodiment, for example, this process can be scheduled to run approximately every 24 hours, at a time ascertained to have the least load on the server system. In other embodiments, however, the process can be scheduled at different intervals, or the process may be manually controlled. In block 101, the method begins by connecting the server system to the first of the affiliate network database servers listed in the database. The method continues in decision block 102 with an assessment of whether the affiliate network has an API to facilitate this connection, or whether connection needs to be performed using a custom-built automated data extraction script. In block 103a, the method includes connecting to the affiliate network's database using their published API. Alternatively, in block 103b the method includes connecting to the affiliate network's database using the custom-built automated data extraction script that reads data from the affiliate network's web-based administration interface.

Once connected, the synchronization process initiates in block 104 where the record for each merchant in the affiliate network's system is compared to its counterpart record for the merchant/affiliate network combination in the system's merchant database. First, at decision block 105, the system checks to see if a particular merchant's records are already in the system's merchant database associated with that affiliate network. Because a merchant may be part of more than one affiliate network, the system is configured to check if the merchant and affiliate network combination already exist in the system's merchant database. If they are not, then in block 108a the method can include creating a new entry in the merchant database with one or more of the following fields:

1. Unique ID

2. Merchant's Name

3. Domain(s)

4. Affiliate Network

5. Merchant ID

6. Program ID

7. “Deep-link unavailable” flag

8. Deep-link syntax

9. “Deep-link override” flag

10. Countries

11. Category

12. Joined Status

13. Status manual override

14. Commission Structure

15. Weighting

16. Comments

For purposes of this specification, the fields are defined as follows:

Unique ID: The internal ID to uniquely identify the merchant in the system's affiliate merchant database.

Merchant Name: Name of the merchant.

Domain(s): The merchant's domain is typically used as the search term to test whether a link added to the system is eligible for rewriting. A merchant may have multiple domains that work with a single affiliate program, for example tesco.com and tesco.co.uk could be part of the same affiliate program.

Affiliate Network: The affiliate network the merchant is associated with.

Merchant ID: The merchant ID used by the affiliate network to uniquely identify the merchant. Each affiliate network can use this field, but certain networks may use different naming conventions.

Program ID: The program ID used by the affiliate network to uniquely identify the program (as merchants can have multiple programs within the affiliate network). Some affiliate networks may not use this field.

“Deep-linking unavailable” flag: A flag indicating whether or not the merchant can work with deep linking. For example, if the flag is enabled, the alternate system devised for supporting non-deep linking merchants may be used.

Deep-link syntax: Deep linking syntax is generally stored at the affiliate network level because they use a URL structure that works with all merchants. In some instances, however, merchants may have their own individual deep linking syntax due to site requirements, and this syntax may need to be manually recorded at the merchant level in the system's merchant database.

“Deep-link override” flag: A flag indicating whether the merchant is using its individual deep link syntax mentioned above or the standard affiliate network deep link syntax.

Countries: A list of countries for which the affiliate can send traffic from to be eligible for commissions. In some embodiments, if this is blank, the default is set to all countries.

Joined Status: The joined status varies slightly from network to network, so a master list can be defined that encapsulates (and maps) the various possibilities:

Joined—accepted into the merchant's program

Not joined—have not applied for the merchant's program yet

Pending—have applied, and the decision is pending with the merchant

Denied—the merchant has chosen not to accept the site into their program

On Hold—the merchant's program is temporarily on hold

Ended—the merchant's program has finished with the affiliate network

Status manual override: If for some reason it may be necessary to override the status provided during synchronization, this flag indicates whether an override is in place or not.

Commission Structure: Listing the commission structure of the deal, so if a merchant is available across multiple networks, the commission may be different (e.g., more profitable) at one network over another.

Weighting: A manually maintained field set by the system's administrator. If a merchant appears across multiple affiliate networks, the administrator can enter the priority in which network is used first for link rewriting (e.g., 9 for highest priority and 0 for lowest priority).

Comments: A free text field allowing the administrator to make notes about a merchant in the database.

It will be appreciated that the foregoing fields and corresponding descriptions are merely provided as examples of possible fields/descriptions for the merchant database, and in other embodiments the database may contain different fields having different characteristics. While a simple network status and separate deep-link statuses and fields are described, the network status and deep-link statuses and fields may be implemented using different techniques. For example, a network status and deep-link status may be combined into a more comprehensive set of statuses.

When adding the domain name for a merchant record, the domain name is typically “cleaned” to ensure only the part before the extension and the extension are recorded (e.g., sony.com, dixons.co.uk, home.com.au). This process can help improve data integrity issues because the link rewriting process depends on this value.

In several embodiments, the system may include an administrative interface to monitor the merchant database and make any manual override changes to merchant's records in the merchant database. The administrative system can be password protected so that only the administrator can make changes. In some embodiments, another user level may be available for read-only access, which is useful for any users that need to see which merchants are available (and without the users making any changes). The administrative interface can be configured to initially list all of the merchants, including their ID, affiliate network, name, domain, joined status, weighting, category, status manual override flag, and deep linking unavailable flag. Each merchant can include an “edit” link in the interface where details regarding the merchant can be entered and maintained. The Edit page can be configured to show the merchant's name, merchant ID, joined status (drop-down list), status manual override (checkbox), deep link linking unavailable (checkbox), weighting, manual deep link, deep link manual override (checkbox), domain name, comments.

In some embodiments, if the “status manual override” checkbox is checked, the joined status drop-down list can be edited. Further, if the “Deep link manual override” checkbox is checked, the manual deep link syntax can be edited. The “Deep linking unavailable” checkbox can be manually set, and it can also be set at an affiliate network level (if the whole network does not support deep linking). The weighting, domain name (in case it is downloaded incorrectly), and comments can also be edited, and each of these changes may be saved. In other embodiments, the administrative interface may have a different arrangement or include different features.

If the merchant and affiliate network combination are already in the database, the method continues in decision block 106 with checking of the merchant's manual override flag in the system merchant database. If it is set, the method continues in block 108c and leaves the merchant's status as is in the merchant database. If it is not set, the method continues in block 108b with updating the merchant's status and details in the system's merchant database. For example, a merchant's program may have been applied for by the system administrator that day, so its status changes from “not joined” to “pending.” In another situation, a merchant may have approved the system's application during the previous 24 hours (or other associated waiting period), so the status has changed from “pending” to “joined.” Merchants that disappear from the affiliate network's system may have their status changed to “ended” within the system's merchant database.

Any status changes can be updated in the system's merchant database so all of the merchant statuses will be correctly reflected. In one embodiment, such changes can be recorded into a report summarizing, for example, (a) the total merchants for each network, and (b) how many have changed to a certain status (e.g. number of new merchants found, number of merchants activated (changed to joined), and number of merchants deactivated (changed from joined)). This report may be made available to an administrator via an on-screen report (an example of such a report of provided in the table below), via an electronic mail message, or using other suitable methods.

| No | New | | | | | | On | | | |
|---|---|---|---|---|---|---|---|---|---|---|
| Merchants | Merchants | Deactivated | Joined | Pending | Rejected | Invited | Hold | Ended | Source | Date |
| 665 | 0 | 0 | 0 | 0 | 0 | 0 | 0 | 0 | affiliatewindow | Jul. 2, 2008 |
| 1356 | 3 | 0 | 0 | 0 | 0 | 0 | 0 | 0 | commission | Jul. 2, 2008 |
| | | | | | | | | | junction | |
| 424 | 0 | 406 | 18 | 0 | 0 | 0 | 0 | 0 | affiliatefuture | Jul. 2, 2008 |
| 541 | 0 | 507 | 24 | 0 | 0 | 0 | 0 | 0 | linkshare | Jul. 2, 2008 |
| 330 | 0 | 274 | 46 | 1 | 0 | 0 | 0 | 0 | tradedoubler | Jul. 2, 2008 |
| 236 | 0 | 71 | 123 | 2 | 0 | 0 | 0 | 0 | buyat | Jul. 2, 2008 |

After the system has either added, updated, or left unchanged the entry for the merchant/affiliate network combination in the system merchant database, the method continues in decision block 109 and checks if there are more merchants within the affiliate network's system to assess. If there are more, the method includes returning to block 104 for the next merchant in the affiliate network's database. If there are no more, in decision block 110 the method includes checking if there are more affiliate networks to assess as part of the regular system synchronization process. If there are, the method includes returning to block 101 for the next affiliate network to assess. If not, the system has completed its regular system synchronization and the system's merchant database is now a current reflection of all affiliated merchants throughout all integrated affiliate networks.

FIG. 5 is a flow diagram illustrating a method or routine for converting designated URLs into affiliate links by the system. There may be one or more triggers that initiate the URL conversion process. These triggers can include, for example, a user driven trigger, a system driven trigger, and an administrator driven trigger. In other embodiments, other triggers can be used to initiate the process. The user driven trigger is shown in decision block 201a where a user either clicks on a designated URL, or a URL is added to the site by a user (in the case of user-generated content) or by an editor (in the case of an editorial site). The system is configured to support both situations, and the site can choose the particular process best suited to the site's nature. For example, a site wishing to apply this system to user-generated content may typically opt for the first process (i.e., a user either clicks on a designated URL), whereas a site wishing to apply this system to publisher driven content may opt for the second process (i.e., a user adds a new URL to the site). When either of these user-driven actions occurs, a script can be called to initiate the URL rewriting process.

A second, system driven trigger is shown in decision block 201b in which the method includes checking whether the regular merchant database synchronization process (described above with reference to FIG. 4) has completed. As this process updates merchants' status, the method can include updating the rewritten URLs to ensure they reflect the new status. For example, if a merchant's status for an affiliate network changes to “not joined,” the rewritten URL needs to revert to its original status. Conversely, if a merchant's status for an affiliate network changes from pending to “joined,” the URL can now be rewritten. This trigger is relevant, for example, when the process being used to rewrite URLs is initiated when a user adds a URL to the site. Where the process being used to rewrite URLs is initiated when a user clicks on a URL, as the rewriting process is done in real time, it does not rely on the database of pre-rewritten URLs.

The third, administrator trigger is shown in decision block 201c in which the method includes checking whether the system administrator has manually updated a merchant's details in the merchant database. Because the administrator can change the merchant's status, “deep link override” flag, “deep link unavailable” flag, and manual deep linking syntax, it is generally necessary to initiate the URL conversion process to ensure the converted URL reflects the merchant's current state.

Once the process has been triggered, the method continues in block 202 with commencing the URL rewriting process for the designated URLs. In several embodiments, the system can include a database table with an entry for each URL that is assessed as part of this process. The URL table can include one or more of the following fields:

1. ID

2. URL

3. New URL

4. Created at

5. Active flag

6. Original Title Tag

For purposes of this specification, the fields are defined as follows:

ID: the unique ID of the link.

URL: The original URL of the skimmed link. If no new URL is present then this link can be used.

New URL: The rewritten URL of the designated URL. If this field is present, then the rewritten link is used.

Created At: The time/date that the link was added to system.

Active flag: A flag indicating whether the link is eligible for the rewriting process. This can be set to inactive if, for example, there is a 404 error when testing or a manual review indicates the page has changed too much/expired.

Original Title Tag: The title tag of the page at skimming time, and used as part of the verification process.

It will be appreciated that the foregoing fields and corresponding descriptions are merely provided as examples of possible fields/descriptions for the URL table, and in other embodiments the table may contain different fields having different characteristics.

In decision block 203, the initial step in this process includes checking whether the URL is flagged as “Active.” If the flag is set, the rewriting process can continue for that URL in block 204. If the flag is not set, the rewriting process is skipped for that URL, and the process continues in block 211 where the system checks if there are more URLs to consider for the rewriting process.

In situations in which the “Active” flag is set, in block 204 the system parses the designated URL to extract just the domain name. For instance, the link
http://www.amazon.co.uk/Kitchen-Devils-302572-Professional-Mezzaluna/dp/B0001GRPV0
   can be parsed to amazon.co.uk. In another example, the link
http://www.gap.com/browse/product.do?cid=15757&pid=568960
   can be parsed to gap.com. This domain name can then be used as a lookup on the Domain Name field in the merchant database for all merchants that have a status of “Joined.”

In decision block 205, the method includes evaluating how many matches there are in the merchant database. If there are no matches, the method skips to block 210b where the “New URL” field is cleared in the URL table in the database. This process can occur if there are no matches at all in the table, or if there had been a match previously, but the matched merchant's status had changed from “Joined” to another status (e.g., “Not Joined”). In either case, the URL cannot be rewritten, and so the “New URL” field is kept empty or should be cleared if it had been populated with a now-redundant rewritten URL.

If there is more than one match with a status set to “Joined” in the merchant database, the method continues in block 206 with evaluating the “Weighting” field per matching merchant. For example, the merchant with the highest value in the “Weighting” field can be chosen for the rewriting process, and carried through to block 207 and the start of the rewriting process. If there is exactly one match with a status set to “Joined” in the merchant database, the method can go directly to block 207 to begin the rewriting process.

There are at least three ways to rewrite a URL. For example, at decision block 207 the method includes evaluating if the “Deep-link unavailable?” flag is set for the given merchant in the merchant database. If it is set, the method continues at block 209c in which an alternate deep linking method is used for the rewrite process. The alternate deep linking method is necessary because some merchants and affiliate networks do not support deep linking within their affiliate programs. This means that a URL that links to a product or content page deep within a site's hierarchy cannot be converted to an affiliate link dynamically. Instead, only a finite set of static web pages determined by the merchant, generally just the homepage, can be used with an affiliate link.

To circumvent this, there are a number of solutions that can be incorporated into the overall system. One solution is to configure the system to open two browser windows when a designated URL is clicked. The window at the back can be via an affiliate link that the merchant has provided to a chosen landing page that works for them. This process can ensure that the cookie gets set in the user's browser. The window at the front can be the original URL that was skimmed with no redirect. Accordingly, if the “Deep link unavailable” flag is set, the method includes obtaining the URL value in the “Deep link syntax” field in the merchant database for the merchant and using it to populate the “New URL” field in the URL table at block 210a. This rewritten URL is the affiliate link to the merchant's chosen landing page, which can be entered manually by the system administrator when setting up new merchants. Another solution is to configure the system to navigate to a system page containing an invisible embedded iframe which opens an affiliate link that the merchant has provided to a chosen landing page that works for them. This page is loaded for a short amount of time, sufficient for the site's affiliate tracking cookie to be downloaded from the merchant's systems. An embodiment of this solution is that it is a fixed amount of time (e.g. 0.75 seconds) or an alternate embodiment is that the maximum time to download a given landing page's cookie is determined and set per merchant. Once this requisite time has passed, the page refreshes to load the deep linked page the user originally added/clicked on. In this manner the merchant's cookie is set in the user's browser, but the original un-rewritten URL is then loaded in the same browser window.

If the “Deep link unavailable” flag is not set, the method continues in decision block 208 where the system checks if the “Deep link override” flag is set. If it is set, the default affiliate network rewriting syntax is not applicable and the system should use the manual deep linking syntax in block 209b. For example, the system administrator can enter the manual deep linking syntax for a merchant in the “Deep link syntax” field in the merchant database, and this value can be retrieved in block 209b and used to populate the “New URL” field in the URL table at block 210a. This rewritten URL is the affiliate link to the deep linked page the user originally added/clicked on based on the manual syntax defined by the Administrator, as opposed to the default for the affiliate network.

If the “Deep link override” flag is not set, the method continues in block 209a where the standard deep linking method is used to rewrite the designated URL. The standard deep linking syntax, for example, is populated automatically during the merchant database synchronization and stored in the “Deep link syntax” field in the merchant database. This value can be retrieved in block 209a and used to populate the “New URL” field in the URL table (at block 210a). This rewritten URL is the affiliate link to the deep linked page the user originally added/clicked on, based on the default syntax defined by the affiliate network.

Once this rewriting process is completed for the designated URL, the method continues in decision block 211 by checking if there are more URLs to consider for rewriting. If there are, the process returns to block 202 and commences the URL rewriting process for the next designated URL (e.g., there may be a large number each evening when the merchant database is updated). If not, the method can finish the URL rewriting process until the next trigger for this process is initiated.

FIG. 6 is a flow diagram illustrating a method or routine for displaying a rewritten URL on a site. The system can be configured to (a) display the rewritten URL proactively on a webpage after it has been added to the site by a user or (b) display the rewritten URL on-demand after a user clicks on the URL. The methods described herein can be used in either situation.

The method begins in block 300 when a user requests to view a webpage on the site that has editorial or user-generated links on it. There are at least two techniques for implementing the functionality of this method as depicted in block 300. Using one technique, the method is initiated when visitors to a webpage click on outbound URLs that have been added to the site by editors (on an editorial site) or users (on a user-generated content site). This is represented by block 301b, which results in the URL rewriting method (FIG. 2) being invoked in real-time as depicted by block 302b. Once this process has completed, the ‘New URL’ field is populated with the rewritten value, and the method continues at decision block 303. Using another technique, the method is initiated when a link is added to a site by an editor or user. This is represented by block 301, where the method takes the designated URL and checks for a pre-populated record in the URL table. For example, in decision block 302a, if the URL is not flagged as “active,” then the method can proceed to block 306c and display the original URL from the “URL” field in the URL table, else, the method continues at decision block 303.

In decision block 303, if the URL is flagged as “active,” the method can include checking whether the URL has a “New URL” value populated in its record in the URL table. If it does not have a value populated, the method can proceed to block 306c and display the original URL from the “URL” field in the URL table. However, if the record has a “New URL” value populated, in decision block 305 the method can include checking whether the “Deep link unavailable” flag is set. If it is set, then in block 306a, the method enables an alternate deep linking method using the “URL” and “New URL” values. This can include, for example, using an iframe in a transitional webpage to load the “New URL” value, which consists of a manually entered affiliate-enabled URL to the merchant's landing page, before redirecting to the original “URL” value. An alternate embodiment of this solution is to add code (e.g., JavaScript) to the site that opens two browser windows simultaneously when a user clicks the designated URL. The window at the back can open the “New URL” value, which consists of a manually entered affiliate-enabled URL to a merchant's landing page. The second window, opened at the front, can open the original “URL” value, which consists of the un-rewritten URL the user added in the first place. In this way, the user can obtain immediate access to the deep linked page they requested, but the affiliate marketing cookie is set by the opening of the iframe or second window in the background. One feature of this method is that the user experience is not compromised, and the second opened window is expected to still be of potential value to the user because it pertains to a higher-level page within the requested merchant's site (generally the merchant's homepage).

If the “Deep link unavailable” flag is not set, then, in block 306b, the standard or manual deep linking method can be used to create a redirect mask URL for the “New URL”. The “New URL” value for the designated URL can be retrieved from the URL table, and the method can include performing redirect masking for this URL in block 306c so that rather than appearing to link to:
http://clkuk.tradedoubler.com/click?p=20047&a=1503186&g=606309&url=http://www.play.com/Games/PlayStation2/4-/183635/Tekken/Product.html?ptsl=1&ob=Price&fb=0,
   the URL appears to link to:
http://go.skimlinks.com/?id=1X1&url=http://us.urbanoutfitters.com/urban.
   Thus, although the URL displayed on the site is still the original URL, its click-through value is the masked URL redirecting to the “New URL” value representing the appropriate affiliate link rewritten based on either standard or manually overridden deep linking syntax. In embodiments in which the designated URL is clicked and the rewriting process happens reactively on-demand rather than proactively when displayed, the same logic can be applied. In such cases, however, the trigger is the designated URL being clicked on rather than being added to the site by a user. The method then finishes displaying the URL by, for example, displaying the URL on the website, and completes.

FIG. 7 is a flow diagram illustrating a method or routine for configuring merchants for use with the system. Although the rest of the system is configured to operate automatically, in the illustrated embodiment the system's administrator manually checks each new merchant as they are integrated into the system to choose the appropriate deep linking method and to set the various flags. In other embodiments, however, this process may also be automated.

In one embodiment, the method can include sending the administrator an alert during the rewriting process. In block 401, for example, when the system is comparing designated URLs with the merchant database and it encounters a matching merchant in the merchant database that have a status of “Not Joined” (block 402), the method can include identifying this merchant in its daily notification holding table (block 403).

The method continues in decision block 404 with checking if there are more URLs to process. If there are, the method can return to block 401 until it has considered all designated URLs at a point in time. In one embodiment, this assessment can be performed daily and the system can accumulate the matching “Not Joined” merchants throughout the day. In still other embodiments, the method can include alerting the system's administrator daily in the form of both a daily electronic mail with details of all newly added merchants with a status of “Not Joined,” as well as updating a report in the administrative interface with these merchant's details (block 405). In other embodiments, however, the assessment and/or reporting process can vary.

In block 206, the administrator applies for all these merchant's affiliate programs via their corresponding affiliate network. This application is typically performed online. While waiting for the merchant to approve the pending application, in block 407 the administrator can evaluate the link rewriting capabilities of the merchant. This can include, for example, checking whether the merchant supports deep linking in block 408). If the merchant does not, then in block 410a the administrator can set the “Deep link unavailable” flag, and in block 411a populate the “Deep link Syntax” field with a static affiliate link pointing to an appropriate landing page within the merchant's site.

If the merchant does support deep linking, in block 409 the administrator can test whether a URL from this merchant rewrites correctly using the standard deep linking syntax provided by the affiliate network. If it does not, then in block 410b the administrator can set the “Deep link override” flag and populate the “Deep link Syntax” field with the manual deep linking syntax necessary for this particular merchant. If, however, the merchant does correctly support the standard deep linking syntax, then the “Deep link syntax” field will typically already have been populated by the system during the nightly merchant database synchronization process with the appropriate standard deep linking syntax.

Upon completion of the above-described steps, the new merchants are configured for use with the system. When the merchant's status changes from “Not Joined” to “Pending” and finally to “Joined” during the merchant database synchronization, the system is able to correctly rewrite any URLs from this merchant added to the site by users.

FIG. 8 is a flow diagram illustrating a method or routine for automatically verifying the integrity of rewritten links. Over time, a rewritten URL may lose its integrity for variety of different reasons, and can take a customer to a broken or invalid page instead of the page that was originally posted to the site. For example, although a rewritten URL is typically correct at the time of rewriting, as time passes, the syntax could have changed or the link could have expired. The following method can be used to automatically verify the integrity of such rewritten links. In one embodiment, this validation process is performed on a regular basis (e.g. once a month per URL, on a weekly rotation to distribute the load evenly across a month or other time period). In other embodiments, however, the schedule can vary.

The method begins in block 501 with the system initiating its regular schedule for verifying the database of URLs. For example, in block 502 the method can include extracting the “Title Tag” value for the first URL in the database. In block 503, the method can then include extracting the “New URL” value from the database, requesting this URL via HTTP, and obtaining the title tag from the requested webpage.

In decision block 504, the method includes comparing the two title tags—the one obtained when the URL was first added to the database at time of posting to the site, and the one obtained during this verification process using the rewritten URL. If they are the same, the system can assume that the rest of the webpage is likely to be acceptably similar to its original state, and therefore this URL passes the verification test. Accordingly, in block 505 the “New URL” value can continue to be used by the system as the rewritten URL.

If they are not the same, however, this does not necessarily mean the rewritten URL is invalid, but that the original title tag from the original URL could have changed slightly. To test this, the method can include extracting the “URL” value from the database, requesting this URL via HTTP, and obtaining the title tag from the requested webpage. Because this is the page the user would have arrived at if they clicked on the original URL now, in block 507 the method includes a comparison of this title tag and the title tag from the rewritten URL will highlight if the rewriting process has broken or affected the destination webpage for the user.

If the title tags are the same, then the system assumes that although the rewritten URL leads to a different page than what the user originally posted to the site, it is the same page as the user would get if they went to that original webpage today. This may be because the publisher has a session flag or date in the title tag that changes daily. Because this is an acceptable outcome from a user's perspective, the URL passes the verification test, and the ‘New URL’ value can continue to be used by the system as the rewritten URL in block 505. If the title tags are not the same, then the method continues in block 508 and tests if the web page requested using the “New URL” value returned a 404 or other HTTP error. If so, the system automatically clears the “Active” flag so it is considered inactive, and the rewriting process is ceased for that URL (block 509). In this case, and also in cases in which there is no match between original and rewritten URL title tags, the system is configured to flag the URL and includes in report to the system's administrator.

At this stage, the automated verification process is generally complete. It is assumed that any URLs flagged in the report to the administrator are not being rewritten correctly by the system, and need manual intervention to correct the rewriting process. In decision block 511, the administrator can check to see if the rewriting process is the cause of the errors, and any errors can be fixed by updating the manual deep linking syntax method. For example, in block 512, the administrator can update the “Deep link syntax” field and confirm that the “Deep link override” flag is set. If not, in block 513 the administrator can check to see if the rewriting process can be fixed by reverting to the alternate deep linking method.

If the alternate deep linking method fixes the rewriting problem, in block 515 the administrator can set the “Deep link unavailable” flag and populate an appropriate affiliate-enabled landing page for the merchant in the “Deep link syntax” field in the merchant database. If this process, however, still does not fix the problem and the link can no longer be correctly rewritten as an affiliate link, then in block 514 the administrator can clear the “Active” flag for the URL in the URL table so it no longer is rewritten.

In block 516, the method can also include checking if there are more URLs to verify in this patch process. If there are, the method returns to block 501 and starts the verification process with the next URL. If there are no more, the verification process completes until the next scheduled operation of this process.

One feature of embodiments of the systems and methods described above is the flexibility and scalability of the disclosed systems/methods. For example, the server system described herein can include at least two possible embodiments for how it can be used: (a) initiated on user upload of a URL to a website, and (b) initiated on user click of a URL on a website. In addition, the server system can be used in a number of embodiments including: (a) initiated on user upload of a company name or keyword to a website (with a keyword/company name to merchant ID mapping table added to the server system), and (b) initiated on publisher upload of a company name or keyword to a website (as above). In addition to the foregoing, the code wrapper used to pass the URL or keyword to the server system by the website can take a number of forms including: (a) JavaScript code, (b) API, and (c) Plug-in to a blog or social media platform. In other embodiments, the server system and/or code wrapper can have different functions and/or features.

In each of these embodiments, any submitted URL can be analyzed and resolved to a valid and verified affiliate link, regardless of the merchant, affiliate network, or syntax of the rewriting process. Further, additional affiliate networks can be quickly and easily integrated because only the custom affiliate synchronization script has to be built. The rest of the system is configured to function properly irrespective of the type or nature of the affiliate network.

One advantage of the methods and systems described herein is that such methods/systems are expected to provide monetization for websites that have struggled until now to monetize without reverting to low-paying and largely ignored advertisements on their site. For example, in many conventional methods of Internet marketing, a site needs to use their website real estate to provide quality content to attract traffic, but to monetize this traffic they need to replace some of the content on their website real estate with advertisements. In many cases, this in turn can negatively affect traffic levels. In contrast with conventional marketing methods, the methods and systems described herein are expected to provide the ability to turn editorial and user-generated content into monetizable content without sacrificing website real estate, quality, and/or integrity.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

In general, the above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments. Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used herein should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

I/We claim:

1. A computing system having a memory and a processor for monetizing editorial and user-generated content via conversion to affiliate marketing links, the computing system comprising:
a data storage component configured to store information regarding merchants and corresponding merchant affiliate programs, wherein the stored information includes, for each merchant, an indication of the status of at least one of the merchant's affiliate programs' and whether the merchant supports deep linking;
a synchronization component coupled to the data storage component and configured to (a) update information regarding merchants and corresponding merchant affiliate programs, and (b) synchronize information regarding merchants and corresponding merchant affiliate programs with one or more partner affiliate networks;
a uniform resource locator (URL) conversion component configured to convert a designated URL into an affiliate link in response to the designated URL being clicked on, added to a webpage, or both, and wherein the URL conversion component is further configured to convert URLs for use with merchants that support deep linking and merchants that do not support deep linking;
a URL data storage component configured to store one or more details regarding the designated URL; and
a URL verification component configured to verify the integrity of the converted designated URL.

2. The computing system of claim 1, further comprising:
a URL redirection component configured to (a) redirect a browser to an affiliate-enabled version of the designated URL when the merchant supports deep linking, and (b) redirect a browser to the affiliate-enabled landing page for the merchant and the original deep linked URL, either by using an inline frame followed by a redirect or by using two concurrently opening browser windows, when the merchant does not support deep linking.

3. The computing system of claim 1 wherein the URL conversion component is configured to convert the designated URL using a standard deep linking syntax method for merchants that support deep linking.

4. The computing system of claim 1 wherein the URL conversion component is configured to convert the designated URL using a manual deep linking syntax method for merchants that support deep linking.

5. The computing system of claim 1 wherein the URL conversion component is configured to convert the designated URL using an alternate deep linking syntax method for merchants that do not support deep linking.

6. The computing system of claim 1 wherein the URL verification component is configured to verify the integrity of a converted designated URL at least in part by comparing the title tag of a web page associated with the converted designated URL to the title tag of a web page associated with the designated URL.

7. A method performed by a computer having a memory and a processor for monetizing editorial and user-generated content via conversion to affiliate links, the method comprising:
receiving an indication that a first URL has been posted to a selected website or clicked on by a user on the selected website;
with a processor, comparing a domain name of the first URL to a predetermined list of merchants and, upon a match between the domain name of the first URL and at least one of the merchants,
upon determining that the at least one merchant supports deep linking, converting the first URL into a second URL using a standard deep linking method, wherein the second URL is an affiliate URL, and
upon determining that the at least one merchant does not support deep linking, converting the first URL into the second URL using an alternate deep linking method; and
after converting the URL into the second URL at a first time, automatically validating the accuracy of the second URL at one or more second times.

8. The method of claim 7 wherein the alternate deep linking method includes opening a first browser window using the second URL and opening a second browser window using the first URL.

9. The method of claim 7 wherein the alternate deep linking method includes loading an inline frame using the second URL.

10. The method of claim 9 wherein the alternate deep linking method further includes redirecting a browser to the first URL at a predetermined period after loading the inline frame.

11. A computer-readable storage medium containing instructions, that when executed by a computer having a memory and a processor, cause the computer to perform a method for monetizing content, the method comprising:
storing information related to a plurality of merchants collected from a plurality of affiliate networks;
receiving an indication of a URL; and
when it is determined that the URL is associated with at least one of the plurality of merchants,
selecting one of the plurality of merchants associated with the URL, and
converting the URL based at least in part on whether the selected merchant supports deep linking.

12. The computer-readable storage medium of claim 11 wherein the stored information includes a deep linking syntax for each merchant that supports deep linking.

13. The computer-readable storage medium of claim 11 wherein the indication of the URL is received in response to the URL being posted to a website.

14. The computer-readable storage medium of claim 11 wherein the indication of the URL is received in response a user clicking on a link associated with the URL.

15. The computer-readable storage medium of claim 11 wherein selecting one of the plurality of merchants includes:
determining a weighting value for each of the plurality of merchants; and
selecting the merchant with the highest weighting value.

16. The computer-readable storage medium of claim 11, further comprising:
periodically validating the accuracy of the rewritten URL.

17. The computer-readable storage medium of claim 11, further comprising:
when the selected merchant supports deep linking, converting the URL using a standard deep linking syntax defined by an affiliate network associated with the selected merchant.

18. The computer-readable storage medium of claim 11, further comprising:
when the selected merchant supports deep linking, converting the URL using a manual deep linking syntax associated with the selected merchant.

19. The computer-readable storage medium of claim 11, further comprising:
when the selected merchant does not support deep linking, loading a first browser window using the converted URL and loading a second browser window using the URL.

20. The computer-readable storage medium of claim 11, further comprising:
when the selected merchant does not support deep linking, loading an inline frame using the converted URL.
